(19) United States
(12) Patent Application Publication
(10) Pub. No.: US 2024/0265367 A1
(43) Pub. Date: Aug. 8, 2024

(54) SYSTEM AND METHOD FOR UNMANNED STORE

(71) Applicant: BLOCKSTORE GROUP OY, Vantaa (FI)

(72) Inventor: Jussi NUMMELA, Espoo (FI)

(21) Appl. No.: 18/562,585

(22) PCT Filed: May 20, 2022
(86) PCT No.: PCT/FI2022/050343

§ 371 Date: Nov. 20, 2023

(30) Foreign Application Priority Data
May 20, 2021 (FI) 20215602

(51) Int. Cl. G06Q 20/20; G06Q 10/0875

(52) U.S. Cl. CPC G06Q 20/208; G06Q 10/0875; G06Q 20/206

(57) ABSTRACT

A method and a system to operate an unmanned store is disclosed wherein secure data processing means, sensors, electronic locks controlled by a computer are used to identify a consumer on shop entry, detect the proximity of the consumer near a cabinet, unlock the cabinet with the consumer in proximity, identify item(s) removed from the cabinet by the consumer, calculate the number of items removed from the cabinet by the consumer, lock the cabinet when the consumer exits the proximity, and charge the consumer for the purchased items removed from the cabinet when the consumer exits the store or indicates that purchasing has ended.

### TECHNICAL FIELD

Generally, the present disclosure relates to an automated store. More specifically, it relates to technical aspects of related payment, shopping, and generally user experience, as well as operational processes for an unmanned store.

### BACKGROUND

Amazon.com launched an automated convenience store in the U.S. in 2016. In China, e-commerce giant Alibaba Group Holding opened a similar store in 2017 and other IT companies soon followed. By the end of 2017, an estimated 200 or so unmanned convenience stores had sprouted up around the country. According to itjuzi.com, a research firm specialized in IT-related venture investments, the business attracted 4.3 billion yuan ($620 million) in 2017 alone.

December 2017, JD.com, China's second-largest online retailer, announced it would suspend its smart shelf business—small, unmanned shops the size of train station kiosks. In July 2018, JD.com unveiled a plan to open 5,000 of them in office buildings and other places in major cities by the end of the year, only to withdraw the plan six months later.

A rash of retailers are opening cashier-free stores, equipped with artificial intelligence (AI), camera technology and sensors that monitor shoppers. Overseas, the technology has been in use since 2016, beginning with China's BingoBox, which uses RFID (Radio Frequency Identification) tags on its items; users then scan the items on a cashier-free checkout and pay with WeChat. Alibaba, China's No. 1 retail e-commerce platform, launched staff-free coffee shop Tao Café in 2017. That same year Netherlands' supermarket chair Albert Heijn began testing a similar service.

In the USA, retail giant Amazon has led the charge with the Seattle debut of Amazon Go in early 2018 and reportedly up to 3,000 of the stores by 2021. Competitors are not lagging behind. Walmart launched its tech-centric grocer, Sam's Club Now, in Dallas in late 2018. Zippin not only develops the checkout-free technology, but also has its own concept convenience store in San Francisco. Kroger also is in the game, announcing a partnership with Microsoft to pilot smart grocery stores in early 2019.

There are also Trust based systems, which will not provide any large scalability. If trusting people to just scan and take those scanned, the theft or misuse cannot be controlled. It will start to eat the business benefits, and thus several trust-based initiatives have been ceased not been able to be profitable and scalable.

While the idea that you can walk into a store, pick what you want to buy, then walk out again—without any interaction with staff or a checkout—and be automatically charged for your purchases is a bit mad and odd, it has taken deep root in the industry. Automated retail is now a broad area including everything from vending machines to unmanned kiosks to unattended grocery stores. In all cases though, the customer is seen as a self-serving entity in a retail environment that is typically unmanned.

### Descriptions of Certain Solutions

Amazon GO: customers enter a store by checking in with their smartphone. They can then browse and add items to their basket as in any grocery store. Every time they pick something up, put it in their basket, or put it back, a combination of AI, computer vision and sensors tracks the movements. When they are done shopping, they just walk out of the store and Amazon automatically takes payment for the items they took.

BingoBox: Their unmanned convenience stores first appeared in China last summer as a collaboration between Auchan and Bingo Fresh, although it claims to have been trialed since August 2016—making it older than Amazon Go. Customers enter the store by scanning a QR code on the door with their smartphone. Once ready to pay, they place their chosen items on a checkout counter that uses image recognition to identify them and calculate the cost. Payment is taken via Alipay or WeChat. Customers must scan another QR code to leave the store, and the door opens once a camera has checked all items have been paid for. There are now more than 300 BingoBox locations in 30 cities across China and growing. Another cool element of the concept is that BingoBox stores are mobile, which means they can be located wherever the owner wants—and in theory this means the stores could be moved around.

JD.COM X-Mart: 2018 JD.com began experimenting with different automated retail models at its Beijing headquarters. Now it has opened a new unmanned store in Indonesia called JD.ID X-mart. A combination of QR code and facial recognition tech lets the customer into the space. They are then tracked via cameras as they shop, with RFID tags keeping track of which products they have picked up. The customers are then automatically charged for anything they leave with. Unlike a lot of these automated retail examples, JD.ID X-mart sells fashion, apparel, beauty, and consumer goods. JD.ID X-Mart has a different area compared to the traditional grocery convenience idea but shows how automated retail can be applied to other sectors.

Stora Enso: Stora Enso claims to have a turnkey solution for automated and unmanned retail. The solution, New Retail/Selfly Store by Stora Enso, merges in-store and online shopping by using sustainable RFID tags for wireless authentication and payment. At the core of the system are Intelligent Cabinets, RFID-enabled e-kiosks designed for on-the-go purchasing using smartphones or smart card. Application markets for the solution include food and beverages in urban settings such as transportation hubs, offices, schools, and hotels. The cabinets are unlocked from a smartphone via any compatible payment app, such as WeChat and MobilePay, or using a smart card payment terminal attached to the cabinet doors. Each item has a tamper-proof, sustainable Stora Enso ECO RFID tag, which is automatically detected by the cabinet. When the cabinet door is closed, the consumer is charged via the app for the items taken out or tokenization process charges via the smart card process the consumer's account.

As a conclusion, there is still no smooth automated consumer shopping set-up created which would have been adapted and gained large use among consumers. In many cases, the solutions that might partially be sufficiently easy to use for the consumer while also somehow scalable technology-wise are complicated in other respects and also expensive. For example, Amazon GO currently requires millions of USD per store to set it up. Typically, the operation is restricted only to one cabinet or then the system is equipped with camera-based systems in combination with smartphone use and visual recognition in check-out places where products that have been collected are first read, then summarized, and finally charged from consumer's account. In these cases that involve a separate check-out read, the accuracy is strongly compromised and will cause costs and bad experience to a store operator and to the consumer. Furthermore, in the existing solutions the functionality and the use of the shop is complex as the consumer is requested to do or participate in multiple different activities to operate in the store. The solutions are not simple and efficient enough in overall. In addition, the existing unmanned store solutions based on RFID, camera recognition and e.g., scales are expensive investment-wise and erode the profitability needed to enable the associated business to grow.

### SUMMARY

The present application solves or alleviates the problem of e.g., queuing at the manned or unmanned counter. Depending on the embodiment, it further solves or alleviates the problem of having to repeatedly expose the smart card in an automated store, thus providing increased security. It further makes the shopping leaner and more efficient.

In a preferred embodiment, a method for execution by an electronic system implementing or comprising a digital store platform is provided. Each consumer (a person, or end-user, of the suggested solution) entering the unmanned store is advantageously identified when s/he enters the store. The proximity of the consumer near a cabinet is detected preferably based on the identification at the entrance and only then the cabinet with the consumer in proximity unlocked. The item(s) removed from the cabinet by the consumer are advantageously identified and the number of items removed from the cabinet by the consumer is further advantageously calculated. After the consumer exits the proximity of the cabinet, the cabinet is locked. The consumer is charged for the purchased items removed from the cabinet when the consumer exits the store or indicates that purchasing has ended.

According to an embodiment, the store indeed comprises one or more, commonly a plurality of, cabinets, preferably functionally connected to or belonging to a digital store platform. The platform is advantageously capable and configured to monitor and/or control the cabinets as dicussed herein. The digital store platform may be configured to assign individually shopping bags, shopping baskets and/or shopping carts with individual IDs for monitoring and tracking. The individual ID may be or be associated with an ID tag. Digital store platform may assign an individual ID for monitoring and tracking based on a mobile application, for instance. Alternatively, or additionally, the digital store platform may assign an individual ID for monitoring and tracking based on a smart card. Alternatively, or additionally, the digital store platform may assign an individual ID for monitoring and tracking using multiple image-based sensoring (and template matching), such as generating each person an individual ID that may be followed with vision-based systems, such as ad hoc facial/body recognition. Alternatively, or additionally, the digital store platform may assign an individual ID for monitoring and tracking using Bluetooth and/or RFID.

According to an embodiment, the digital store platform assigns the individual ID to the customer.

According to an embodiment, the consumer may be automatically technically identified, purchasing may be automated, and payment transaction may be automatically charged from a bank account, a smart card or based on any other monetary transaction system.

According to an embodiment, the store item database may be updated based on purchases from the one or more cabinets.

A system for executing the above-described method is also suggested and disclosed herein.

According to an embodiment, the system may comprise or implement a digital store platform with at least one computer with display, processor, memory, and/or data transmission equipment (receiver, transmitter, transceiver, and/or network adapter, etc.) having means configured (e.g., applicable hardware elements suitably functionally configured via applicable functional logic such as software, for example) to execute at least one action selected from the group consisting of: data and/or data transmission encryption, consumer identifier, such as an individual ID assignation, and enablement of data transmission between the system and each individual consumer with the individual ID. Data and data transmission are advantageously encrypted using private keys, public keys, symmetric keys, asymmetric keys, message authentication codes, and/or digital signatures. Data transmission between the system and each individual consumer with the individual ID is enabled using e.g., UHF, NFC, RFID, BLE, wireless network protocols (Wi-Fi), wireless computer network (WLAN) and/or infrared light.

According to an embodiment, the digital store platform with at least one computer may control the store electronics, including, but not limited to consumer identification unit, consumer monitoring and tracking unit, consumer charging unit, store facility management unit.

The identification unit may include, but is not limited to, bank account associated identification module, fingerprint sensor device, camera, Bluetooth device and/or RFID device, PIN entry device, NFC device, and/or electronic lock. The consumer charging unit may include, but is not limited to, bank account associated identification module, fingerprint sensor device, camera, Bluetooth device and/or RFID device, PIN entry device and/or NFC device. The consumer monitoring and tracking unit may include, but is not limited to, motion sensor, light sensor, camera, Bluetooth device, RFID device, and/or GPS device, cabinet proximity sensor, and/or electronic lock. The store facility management unit may include, but is not limited to, cabinet monitoring and controlling device, cabinet proximity sensor, electronic lock, environment temperature monitoring and controlling device, environment moisture monitoring and control device.

According to an embodiment the system may maintain and update at least one inventory file database of the delivered and purchased items in real-time. The system may further enable real-time data transmission between the different units and the database.

According to an embodiment, the system may comprise at least one functional element selected from the group consisting of: a secure interface or module to identify a consumer, data processing means to assign an identifier corresponding to the consumer, data processing means and sensor or sensors to identify proximity of the consumer near a cabinet, an electronic lock programmed to unlock only when the consumer is in the proximity of the cabinet and lock when the consumer is not in the proximity of the cabinet, data processing means and sensor or sensor to identify items removed and/or returned into the cabinet, data processing means to detect termination of the purchasing process, and data processing means to charge the consumer for the purchased items.

The present solution is to creatively and effectively combine components/technologies available as separate components or known in theory to the proximity detection and creating an ID to the user, which is followed, matching to the cabinet ID and product(s) ID(s) picked by the consumer. A cabinet may be a closed (preferably openable/closenable) container. Cabinet may be or comprise one or more store shelves, such as a stack of store shelves. Preferably the cabinet has one or more automatically (un)lockable doors (e.g. electric locks with preferably remote control via the platform, for instance). A cabinet may be or comprise an intelligent consumable storage, a box automaton, or a locker. A cabinet may have temperature and/or humidity control preferably of remote type (e.g., via the platform). A cabinet may be or comprise a fridge or a freezer.

Item level traceability with a single item identification method of the consumables is combined with the proximity detection of a consumer approaching the cabinet. Item level identification may be based on secure automated ID code reading technology, such as RFID (Radio Frequency Identification) technology. Item level identification may be based on weight-based sensor systems and/or image-based systems. Item level identification may be used to identify consumables and consumers. Bluetooth, RF and/or image-based sensoring may be used to detect and position consumers with identifiers. Intelligent cabinet considered herein may open (unlock and optionally also e.g., door open) automatically based on consumer identifier and its proximity to the intelligent cabinet. Intelligent cabinet may remain closed (e.g. door closed and locked) based on consumable identifier and/or consumer identifier. Automatically opening cabinet gives a consumer an experience that (s)he would be using a standard cabinet. An unmanned store may have multiple consumable cabinets.

Automated unmanned store collects the total sum of purchased goods or items and enables final payment after the shopping process. Payment may be automated. Notable is the inventory of remaining items is based on reading of the items picked or not picked up. Therefore, the inventory needs to happen in the modular intelligent cabinets or attached highly controlled reading units and thus inventory database may be controlled for security and high yield of system operation.

According to an aspect of the solution the consumer may be identified based on a smart card, intelligent cabinets may open for purchasing based on the identity and proximity of the consumer's smart card, the intelligent cabinet may identify the quality and quantity of the items the consumer has taken, the intelligent cabinet may add the price of the items to consumer's invoice, the intelligent cabinet may update the store inventory database, and payment may be automated from the smart card when the consumer leaves the store or otherwise indicates that the purchasing has terminated.

According to another aspect of the solution the consumer may be identified based on a smart card, the consumer may obtain a shopping bag, shopping basket or shopping cart that includes a digital store platform assigned individual ID. The individual ID of the shopping bag, shopping basket or shopping cart may be further associated with the consumer's smart card. Intelligent cabinets may open for purchasing based on the identity and proximity of the consumer's shopping bag, shopping basket or shopping cart with an individual ID, the intelligent cabinet may identify the quality and quantity of the items the consumer has taken, the intelligent cabinet may add the price of the items to consumer's invoice, the intelligent cabinet may update the store inventory database, and payment may be automated from the smart card as the shopping bag, shopping basket or shopping cart with the individual ID is returned.

According to another aspect of the solution the consumer may be identified based multiple image-based sensoring. The multiple image-based sensoring may be used as an ID. The image ID may be associated with the consumer's smart card. Intelligent cabinets may open for purchasing based on the identity and proximity of the consumer's image ID, the intelligent cabinet may identify the quality and quantity of the items the consumer has taken, the intelligent cabinet may add the price of the items to consumer's invoice, the intelligent cabinet may update the store inventory database, and payment may be automated from the smart card when the consumer leaves the store or otherwise indicates that the purchasing has terminated.

According to another aspect of the solution the consumer may be identified based Bluetooth and/or RFID. The Bluetooth-based ID and/or RFID may be used as an ID. This ID may be associated with the consumer's smart card. Intelligent cabinets may open for purchasing based on the identity and proximity of the consumer's ID, the intelligent cabinet may identify the quality and quantity of the items the consumer has taken, the intelligent cabinet may add the price of the items to consumer's invoice, the intelligent cabinet may update the store inventory database, and payment may be automated from the smart card when the consumer leaves the store or otherwise indicates that the purchasing has terminated.

According to another aspect of the solution the consumer may be identified based mobile phone application. The mobile phone application may be used as an ID. This ID may be associated with the consumer's smart card. Intelligent cabinets may open for purchasing based on the identity and proximity of the consumer's mobile phone application ID, the intelligent cabinet may identify the quality and quantity of the items the consumer has taken, the intelligent cabinet may add the price of the items to consumer's invoice, the intelligent cabinet may update the store inventory database, and payment may be automated from the smart card when the consumer leaves the store or otherwise indicates that the purchasing has terminated.

In certain cases, a strong identification is needed (such as alcohol, tobacco, other products with age restrictions or pharmaceuticals). In these cases, the strong identification can be done in the store. The strong identification may be arranged with a mobile phone utilizing strong identification done by the consumer and combined with mobile phone cameras for facial detection. The pre-approved facial recognition may have been done earlier. This strong identification may be connected directly to the cabinet in use and thus with similar process tracking the individual ID that was created as described above, the cabinet may be unlocked based on the proximity of the consumer and the purchase may be done. This can be further reinforced by using, for example, BLE detection of the mobile phone while a mobile phone app is doing facial detection in front of the selected cabinet. Even further, the mobile phone may use also a simple QR code existing in the cabinet displays to read the QR code with the back camera and making the strong identification related facial recognition on the front camera. Any other similar processes that match the strong identification to the facial recognition of the mobile phone application and connecting that with the proximity detection for the cabinets to enable them to open may be used.

### BRIEF DESCRIPTION OF THE DRAWINGS

Next the solution will be described in greater detail with reference to the accompanying drawings, in which:

FIG. 1 is a flow diagram disclosing shopping process description with phone application-based proximity sensoring.

FIG. 2 is a flow diagram disclosing shopping process description with smart card-based system and proximity sensoring connected to this.

### DETAILED DESCRIPTION

Below are the detailed descriptions of the unmanned purchasing process and the flow diagrams of the shopping process enabling the unmanned store functionality by using item level detection enabled consumable storages, cabinets, or similar locked units for storing the items, products, or goods. Consumable storage, cabinet and locker may be used interchangeably. Items, products, or goods may be used interchangeably. The unmanned store functionality may be controlled by a digital store platform. The digital store platform may have sub-platforms. The digital store platform may comprise a payment platform and a cabinet platform. The payment platform and the cabinet platform may be integrated to the digital store platform. The digital store platform, the payment platform and the cabinet platform may be separate platforms. Terms basket, bag, and trolley interchangeably refer to the solution for carrying purchases in the store.

E.g., a credit/debit card may be called a smart card. Updating the consumer's virtual shopping basket or purchase list may be called tokenization. In tokenization each item is tokenized into the digital store platform for payment on check out.

Processing means may include, e.g., a microprocessor, microcontroller, programmable logic, central processing unit and/or graphics processing unit. Processing means may constitute an operating device for a digital store platform.

Data processing means may include, e.g., encryption algorithm, validation algorithm, access control system of an electronic lock, hand-shake protocol, digital signal processing, quantum coding, cloud computing, machine learning, and/or template matching, database, logging, and/or, storage.

Encryption means may include, e.g., private keys, public keys, symmetric keys, asymmetric keys, message authentication codes, and/or digital signatures, each of which may be independently operated by the processing means. Encryption may be assigned to all data and data transmission.

Means for assigning a consumer identifier, an individual ID, may include, e.g., registering the consumer specific smart card information, device identification code, media access control (MAC) address, ultra-high frequency (UHF) code, near field communication (NFC) code, radio-frequency identification (RFID) tag, Bluetooth low energy (BLE) code, personal identification number (PIN) code, and/or facial recognition, each of which may be independently operated by the processing means. The consumer identification assignment means may be included in the digital store platform.

Data transmission means within the system may include, e.g., local area network (LAN), UHF, NFC, RFID or BLE, wireless network protocols (Wi-Fi), wireless computer network (WLAN) and/or infrared light. The local area network may be realized, e.g., with optical fibre, parallel cable, USB, RS45, and/or integrated printed circuit board.

Data transmission means between the system and each individual consumer with the individual ID may include, e.g., UHF, NFC, RFID, BLE, wireless network protocols (Wi-Fi), wireless computer network (WLAN) and/or infrared light.

Store electronics may include, e.g., store lighting, lighting automation, heating ventilation & air-conditioning, security camera, electronic lock, access control system, alarm system, and/or any electronics required by the local law. In addition, store electronics may be included in the digital store platform.

Means for identifying a customer may include, e.g., bank account associated identification module, fingerprint sensor device, camera, UHF device, NFC device, RFID device, BLE device, PIN entry device, and/or electronic lock, each of which may be independently operated by the processing means. Means for identifying a customer may be called a consumer identification unit. The consumer identification unit may be included in the digital store platform.

Means for controlling consumer monitoring and tracking may include, e.g., a motion sensor, light sensor, camera, UHF device, NFC device, RFID device, BLE device, GPS device, cabinet proximity sensor, cabinet monitoring & controlling device and/or electronic lock, each of which may be independently operated by the processing means. The consumer monitoring and tracking means may be called a consumer monitoring and tracking unit. The consumer monitoring and tracking unit may be included in the digital store platform.

Means for controlling consumer charging may include, e.g., bank account associated identification module, fingerprint sensor device, camera, UHF device, NFC device, RFID device, BLE device and/or PIN-code entry, each of which may be independently operated by the processing means. The consumer charging means may be called a consumer charging unit. The consumer charging unit may be included in a digital store platform.

Means for controlling the store facility management unit may include, e.g., cabinet monitoring and controlling device, cabinet proximity sensor, electronic lock, environment temperature monitoring and controlling device, environment moisture monitoring and control device, each of which may be independently operated by the processing means. The store facility management means may be called a store facility management unit. The store facility management unit may be part of the store electronics. The store facility management unit may be included in the digital store platform.

The digital store platform may additionally maintain and update at least one inventory file database of the delivered and purchased items in real-time and enable real-time data transmission between the units and the database.

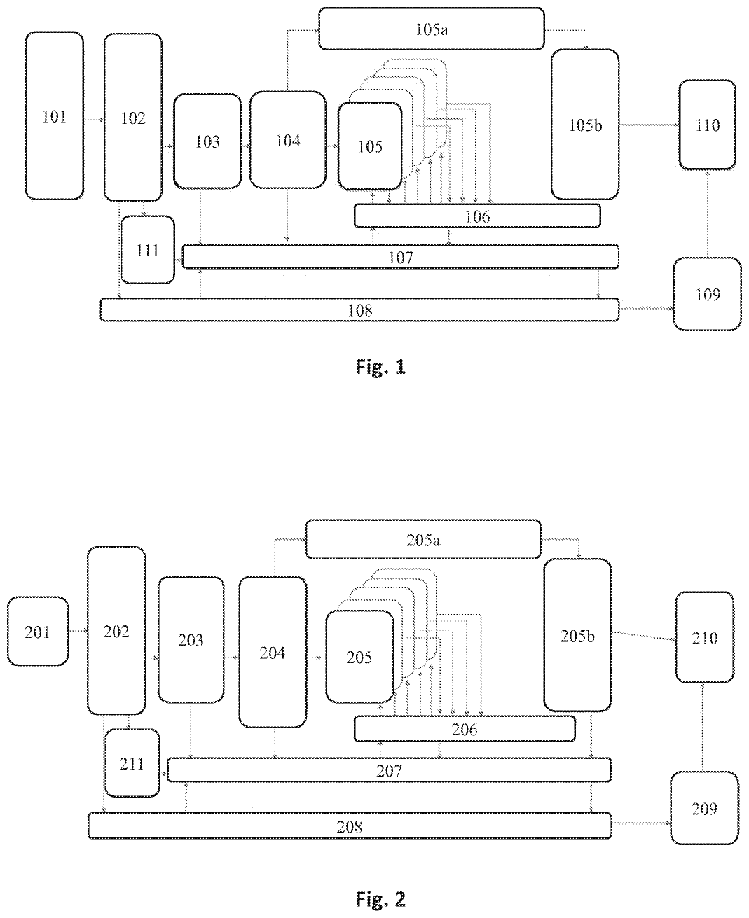

FIG. 1 is a flow diagram disclosing shopping process description with mobile phone application-based proximity sensoring. It details an unmanned store and a mobile phone application that it functionally arranged to communicate with the digital store platform of the unmanned store.

According to an aspect of the solution, a consumer, who has downloaded, installed, and is using this specific mobile phone application built for this purpose, is approaching an unmanned store. At this point, when allowed by the consumer, the application may identify from the location of the consumer that the consumer is approaching one of the above-mentioned unmanned stores. The digital store platform 107 may start to prepare activities to enable the smooth shopping process based on this information, such as enabling fast response times, preauthorization of the smart card etc 101. When consumer enters the store, Bluetooth reader may detect the consumer's smartphone and start to track it 102. Bluetooth proximity detection systems may provide a location accuracy as low as 3 cm in a room like 20-50 m². The accuracy depends on the number of Bluetooth readers/beacons that have been located in the room. At this stage, the consumers credit balance may have been checked and possible deposit may have been reserved, and shopping of the consumer may be allowed/verified. The consumer tracking after this first BLE detection may be connected to visual recognition or similar sensoring based tracing of this person. Tracking may use similar RF technology as Vayyar technology.

When the consumer is close enough to the cabinet, the system may give an indication based on the built algorithm to open a specific cabinet the consumer is close to 103. Then the locking mechanism may open 104, 106, and the consumer may pick one or as many items or products s/he wants 105, 105a, 106. While to door is open the consumer may put the item(s) back if needed. When all the needed items have been taken from the cabinet and the door is closed, the door may be automatically locked 105b, 106. This secures that the consumer/smartphone under tracking is the only person using one cabinet at the time. Instead of the current intelligent cabinet systems, in this set-up the consumer may change her/his mind and, for example, desires not to take a certain product. Then, the deposit and tokenization 108 may be activated again when the consumer is close enough to the cabinet. The cabinet's lock may open again 105, 106, and the consumer may put back the item(s) s/he has previously taken. After that the consumer may proceed to the next cabinet and to the next cabinet and build the e-commerce like virtual basket, but in a physical way. Finally, when all needed items or goods have been taken, the sum of all items may be presented visually to the consumer via the mobile phone application 111 or when cabinets have separate displays connected to the backend system, i.e., the digital store platform 107, the consumer may just leave the store 110 and the digital store platform detects that the person is out of the store and makes the final payment 109. As a process this application-based system, is the most advanced shopping process created for unmanned store. It gives high reliability due to itemization (RFID can give around 99% accuracy), simplifies the consumer tasks, speeds-up the purchasing, and, because of the locked cabinet system, prevents or diminishes the misuse and thefts.

FIG. 2 is a flow diagram disclosing shopping process description with smart card-based system and proximity sensoring connected to this.

According to an aspect of the solution, a consumer enters an unmanned store 201 and starts the shopping process by tapping with contactless payment or enters a PIN code to a terminal in the payment platform of the digital store platform 202 to verify the consumer's smart card 211. After that, the payment platform verifies the consumer's account and starts tokenization 208. After the purchases, the payment platform finalizes and ends the shopping process 208, 209. During tokenization the following steps will preferably take place:

Option A) The payment terminal may deliver ID related to the smart card to the digital store platform (backend system) 207, or such an ID is created in the platform for the consumer 203, i.e., the consumer is connected to the tokenization 208. The consumer may then proceed for shopping and open the cabinet 204, 205, 205a, 205b, 206 with her or his smart card 211. No payments will be taken until shopping has ended. The smart card may be used only for the user identification with the UID element which every smart card carries. In this process, the HF reader on the cabinet may read the smart card ID 202, 211 and deliver that to digital store platform 207, which may inform the cabinet platform to open and enable the purchase process from the cabinet 204, 205, 206. The HF reader may also be used with higher power enabling proximity detection to 5-30 cm range, for example. Higher power HF reading may provide similar kind of proximity experience as described with the mobile phone application-based system above. The card shall be in the hand of the consumer or in the readable distance. After consumer has purchased items from these different cabinets 205, 205a the digital store platform 206, 207 may collect and summarize all the purchases from various cabinets 205, 205a and deliver the total sum to the payment platform 205b, the consumer may finalize the shopping in a separate HF reader, at the payment terminal or after a set time limit has exceeded, after which the tokenization may end in the payment platform and the smart card account may be deducted by the amount associated to purchased items 210. Then the shopping processes is ended 209.

Option B) The payment terminal may deliver the ID related to the credit to the digital store platform (backend system), or such an ID is created in the platform for the consumer, i.e., the consumer is connected to the tokenization. Then the consumer may select from a screen connected to the payment terminal to use, for example, a shopping basket, and automated lock/release-controlled system may provide this basket to the consumer. Alternatively, the consumer may use her/his smart card to pick up a basket from a cabinet. The basket may have an identifier attached on it, for example UHF, NFC, RFID tag or BLE Bluetooth. After that, the digital store platform may follow the ID on the basket, or alternatively the consumer may use her or his smart card to open the cabinets. When, for example, the cabinets have a BLE reader on it and the baskets have a BLE identifier/beacon attached to them, by using a proximity detection software, each one of the cabinets may detect when the basket is close to the cabinet and open the precise cabinet in question. Alternatively, for example UHF or RFID tags may be attached to the baskets and used similarly for proximity detection. A software for RF detection may be a Vayyar solution or similar a similar solution to detect when basket is close to the cabinet and open the cabinet. The functionality described above may give the consumer an automated and smooth experience to purchase products or items easily from various cabinets without the need to repeatedly show their smart card for all the items and/or all the HF readers on the cabinets. The ending of the shopping process may be either bringing back the basket into the first cabinet or similar basket retrieval/collector system thereafter closing the shopping process and invoicing the consumer's account. Reading the smart card at the exit or having a time-out based on a long break in smart card or basket usage may alternatively end the shopping process. If the unmanned store is using baskets with ID tags, the basket may have a specific price associated to them when assigning them to the smart card in order to prevent thefts. Pricing the baskets may also enable the consumer to buy one or several baskets or consider to re-use the basket as their own shopping basket. The ID of the basket may then be more permanently assigned or connected to the consumer's smart card.

A simplified description of a consumer shopping process with a basket with an ID tag may have following steps: the consumer enters an unmanned store, uses her/his smart card on the payment terminal (PIN+selects option basket or uses just smart card to open the first cabinet), picks up a basket from a cabinet and continues shopping. When approaching the cabinet, the cabinet may open automatically, and consumer may easily pick items or products from the cabinet. Additionally, the consumer may as easily put back any items or products if, for example if s/he after consideration concludes that s/he does not really need them. When moving to the next cabinet, the previous cabinet may close. After all needed items or goods are in the basket, the consumer may go back to the first cabinet, i.e., the basket cabinet, switch purchases to her/his own bag and return the basket as empty into the first cabinet thus finalizing the shopping process. The return of the basket automatically launches the payment platform charging process and invoices the purchased items from the consumer's smart card.

Notable is that not necessarily a basket or similar ID carrier is needed if image recognition is built to follow a consumer providing e.g., a PIN code to a payment terminal and giving an individual ID to the consumer to be followed. In this case, the purchase process would be following: the consumer enters an unmanned store, uses her/his smart card on the payment terminal (PIN+selects option and accepts image based facial/body recognition and creation of an individual ID). When approaching the cabinet, the cabinet may open automatically, and consumer may easily pick items or products from the cabinet. Additionally, the consumer may as easily put back any items or products if, for example if s/he after consideration concludes that s/he does not really need them. When moving to the next cabinet, the previous cabinet may close. After all the needed items or goods have been picked up, the consumer finalizes the shopping process by just walking out of the store. The individual ID generated to the consumer will be deleted after person exits the store and payment is taken from the consumer's bank account, matching the sum purchased from the cabinets.

Notable further is that in the payment options contemplated here we have the itemization. This itemization may take place in the warehouse, brand owners' manufacturing site or it may be done by the local store owner at the store site, for instance. Otherwise, the system requirements may become expensive and unreliable. For example, sufficient image-based recognition requires several cameras, accurate image recognition, sophisticated tracking algorithms, and machine learning to reliably keep track of all the items, and consumers in an unmanned store at all times. For example, various software companies have given statements that just image recognition could be on a sufficient level for this kind of use in the next coming ten years—if everything would be solely based on image-based systems, and still the products would be as SKU (stock keeping unit), not individual products.

1. A method for execution by a digital store platform for operating an unmanned store comprising one or more cabinets, wherein
a consumer is identified when the consumer enters the store;
an individual ID is digitally assigned for the consumer;
the consumer is monitored and tracked based on the individual ID;
the proximity of the consumer near a cabinet is detected based on the individual ID generated at the entrance;
the cabinet with the consumer in proximity is unlocked;
item(s) removed from the cabinet by the consumer are identified;
the number of items removed from the cabinet by the consumer is calculated;
the cabinet is locked when the consumer exits the proximity; and
the consumer is charged for the purchased items removed from the cabinet when the consumer exits the store or indicates that purchasing has ended.

2. The method according to claim 1, wherein one or more of the cabinets comprise temperature and/or humidity control.

3. The method according to claim 1, wherein a digital store platform assigns individually shopping bags, shopping baskets and/or shopping carts with individual IDs for monitoring and tracking.

4. The method according to claim 3, wherein the individual ID is embodied as an ID tag.

5. The method according to claim 1, wherein a digital store platform assigns the individual ID for monitoring and tracking based on a mobile application.

6. The method according to claim 1, wherein the digital store platform assigns an individual ID for monitoring and tracking based on a credit/debit card or a smart card.

7. The method according to claim 1, wherein the digital store platform assigns an individual ID for monitoring and tracking using multiple image-based sensoring (and template matching).

8. The method according to claim 1, wherein the digital store platform assigns an individual ID for monitoring and tracking using Bluetooth and/or RFID.

9. The method according to claim 1, wherein the identification of the consumer is a strong identification.

10. The method according to claim 1, wherein the consumer is automatically identified, purchasing is automated, and payment transaction is automatically charged from a bank account, smart card, or other online monetary exchange system.

11. The method according to claim 1, wherein the store item database is updated based on purchases from the one or more cabinets.

12. A system for executing the method in accordance with claim 1.

13. The system according to claim 12, comprising a digital store platform with at least one computer with display, processor, memory, and/or data transmission equipment configured to execute at least one action selected from the group consisting of:
to encrypt all data and data transmission using private keys, public keys, symmetric keys, asymmetric keys, message authentication codes, and/or digital signature;
to assign the consumer an identifier, an individual ID;
to enable data transmission between the system and each individual consumer with the individual ID using UHF, NFC, RFID, BLE, wireless network protocols (Wi-Fi), wireless computer network (WLAN) and/or infrared light;
to control the store electronics including, but not limited to, consumer identification unit, consumer monitoring and tracking unit, consumer charging unit, store facility management unit;
to control the identification unit including at least one of the following: bank account associated identification module, fingerprint sensor device, camera, Bluetooth device and/or RFID device, PIN entry device, NFC device, and/or electronic lock;
to control consumer monitoring and tracking unit including at least one of the following: motion sensor, light sensor, camera, Bluetooth device,
RFID device, NFC device GPS device, cabinet proximity sensor, cabinet monitoring and controlling device and/or electronic lock;
to control consumer charging unit including at least one of the following: bank account associated identification module, fingerprint
sensor device, camera, Bluetooth device and/or RFID device, PIN entry device and/or NFC device;
to control store facility management unit including at least one of the following:
cabinet monitoring and controlling device, cabinet proximity sensor, electronic lock, environment temperature monitoring
and controlling device, environment moisture monitoring and control device;
to maintain and update at least one inventory file database of the delivered and purchased items in real-time; and
to enable real-time data transmission between the units and the database.

14. The system according to claim 12 comprising at least one functional element selected from the group consisting of:
a secure interface or module to identify a consumer;
a secure interface or module for strong identification of a consumer;
data processing means to assign the identifier, the individual ID, corresponding to the consumer;
data processing means and sensor or sensors to identify proximity of the consumer with the individual ID near a cabinet;
an electronic lock programmed to unlock only when the consumer with the individual ID is in the proximity of the cabinet and lock when the consumer with the individual ID is not in the proximity of the cabinet;
data processing means and sensor or sensor to identify items removed and/or returned onto or into the cabinet;
data processing means to detect termination of the purchasing process; and
data processing means to charge the consumer with the individual ID for the purchased items.
